(19) United States
(12) Patent Application Publication
(10) Pub. No.: US 2008/0165479 A1
(43) Pub. Date: Jul. 10, 2008

(54) Display Screen Used in Game Machine

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/620,402

(22) Filed: Jan. 5, 2007

(51) Int. Cl. G06F 1/16

(52) U.S. Cl. 361/681

(57) ABSTRACT

A display screen is used in a game machine having a plurality of heat-dissipating holes. The display screen includes a screen body having a bottom surface and a base coupled to the bottom surface of the screen body. The base has a plurality of latches arranged correspondingly to the heat-dissipating holes to fasten the heat-dissipating holes such that the screen body is fixed on the game machine. The display screen can be easily to be assembled on the game machine, that is, the display screen has a neat structure and is easy to be installed. The assembly only needs an action without any addition tools to combine the display screen with the game machine successfully.

### BACKGROUND

1. Field of the Invention

The present invention relates to display screens used in game machines, and more particularly to a display screen used in a game machine capable of facilitating to be assembled.

2. Description of the Related Art

Game machines are a kind enjoyable game tool and are popular in the Children and young people. To satisfy needs of game players, game manufactures will research and develop the new kinds of the game machines forever without stopping. With the development of the semiconductor technology, the new kinds of the game machines have been added many new functions.

Now the game machines are mainly designed and manufactured by several manufacturers, such as Microsoft, Sony, and Nintendo, etc. The game machines, for example, XBOX-360 manufactured by the Microsoft, can not only play games, but also have some new functions. The XBOX-360 increases the processing speed and the efficiency in wholes so that it can support needs of the professional players, such as high quality display image, and high processing speed, etc. The XBOX-360 can be also used to play music, access the Internet, process and operate files, etc. The users can connect the XBOX-360 with portable music player devices, a digital camera, a personal computer, or a TV in a parlor directly to play diversified audio and video source on hand to enjoy the full audio-visual amusements. That is, the new kinds of the XBOX-360 have developed in a direction for being an enjoyable center of a family. However, the XBOX-360 can not be used as a single, and the XBOX-360 usually are used with the TV screen or the display of the computer, so that the spaces and the operating positions of the XBOX-360 are limited.

What is needed, therefore, is a display screen used in a game machine capable of facilitating to be assembled.

### BRIEF SUMMARY

The present invention is to provide a display screen used in a game machine. A screen body of the display screen can be combined on the game machine by heat-dissipating holes and a bottom plate of the game machine to replace the conventional TV screen or the display of the computer connected with the game machine. The display screen used in the game machine is not limited by the space and the position, occupies little space, and is easy to be received and schlepped.

Furthermore, the present invention is to provide a display screen used in a game machine, which has a base fasten able into a plurality of heat-dissipating holes arranged on the game machine itself, to integrate a screen body of the display screen with the game machine. The display screen used in the game machine has a simple structure, and the assembly only needs an action without any addition tools so that it is used very simply and easy.

The present invention provides a display screen used in a game machine having a plurality of heat-dissipating holes. The display screen includes a screen body having a bottom surface; and a base coupled to the bottom surface of the screen body, the base having a plurality of latches arranged correspondingly to the heat-dissipating holes to fasten the heat-dissipating holes such that the screen body is fixed on the game machine. The assembly only needs an action without any addition tools to combine the display screen with the game machine successfully. The present invention is a display screen used in a game machine, the display screen is used in a game machine having a plurality of heat-dissipating holes, in detail, the game machine may be a XBOX-360. The XBOX-360 has the plurality of heat-dissipating holes arranged at the two sides thereof, and the latches can be arranged at two sides of the base, which can facilitate to combine the display with the XBOX-360. The display screen of the present invention has a simple structure in whole, and is easy to be received and schlepped with occupying little space. The display screen can be used without any limit of the time and the operating position.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded view of the display screen used in a XBOX-360;

FIG. 2 is a schematic, exploded view of a latch of FIG. 1;

FIG. 3 is a schematic, exploded view of the display screen integrated with the XBOX-360 of FIG. 1;

### DETAILED DESCRIPTION

Reference will now be made to the drawings to describe a preferred embodiment of the present display screen used in a game machine, in detail.

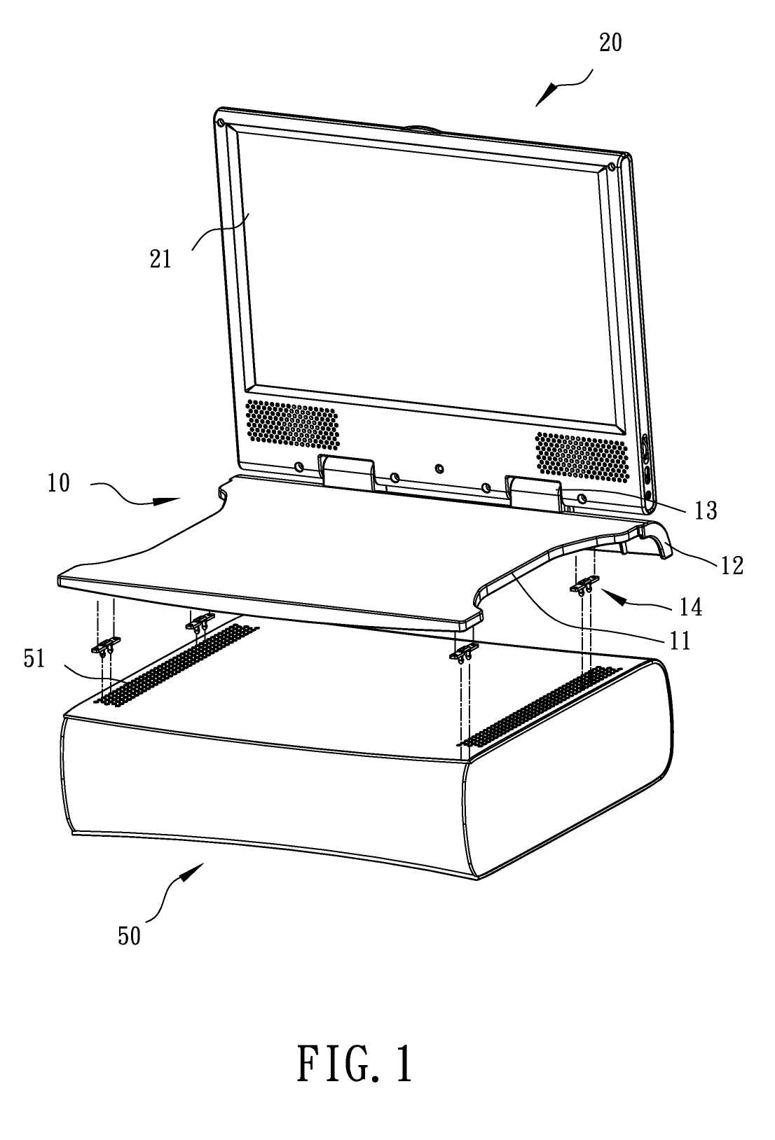

Referring to FIG. 1, a display screen and a game machine according to one embodiment of the present invention is shown. The display screen is used in the game machine 50 such as an XBOX-360. In this exemplary embodiment, the display screen includes a base 10 and a screen body 20. The base 10 is configured for supporting the screen body 20, and includes a bottom plate 11 and a back plate 12. A joint 13 is arranged behind the bottom plate 11 to be coupled with the screen body 20 such that the screen body 20 can rotate to open and close with the base 10. The screen body 20 is a liquid crystal display having advantages, such as low radiation, compact space and low power-dissipation, etc. The liquid crystal display integrated with the game machine 50, produces an integrative aesthetic feeling. Furthermore, a screen image 21 of the screen body 20 is designed and facing towards the bottom plate 11 such that the screen image may be received towards the bottom plate 11 to be prevented form being destroyed. The back plate 12 is designed to correspond to the show of the game machine 50 to have a corresponding arc shape. Furthermore, the back plate 12 is connected with the bottom plate 11 via the joint 13 to cover the back of the game machine 50 and beautify the integrative show.

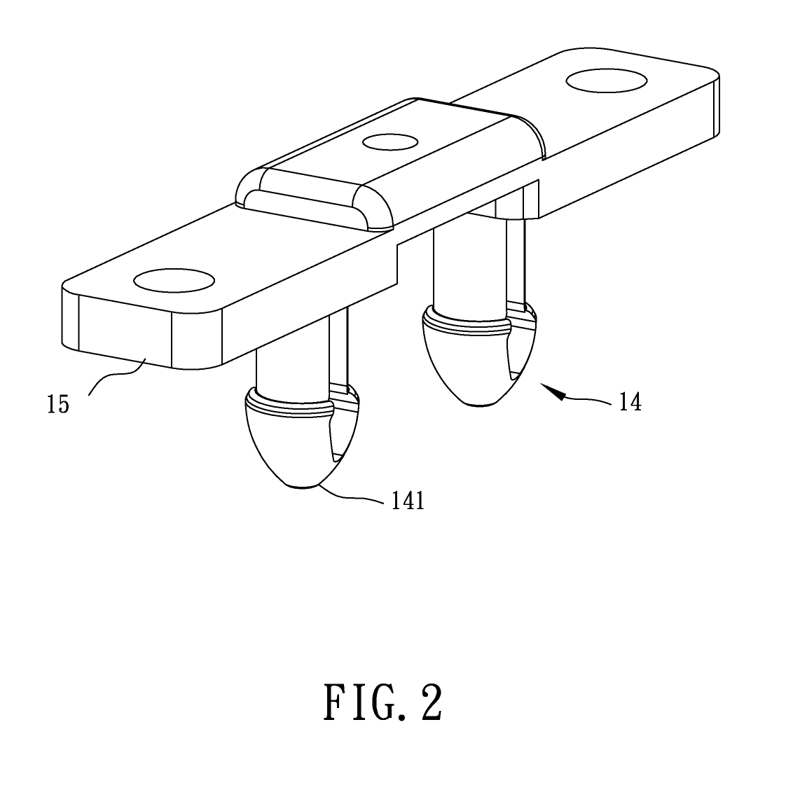

In addition, a plurality of latches 14 is arranged at the base 10 as shown in FIG. 2. In this exemplary embodiment, each latch 14 includes a head portion 141 having a width larger than an aperture of heat-dissipating holes 51 of the game machine 50. The head portion 141 is made of an elastic material having little flexible property. The head portion 141 can pass through the heat-dissipating hole 51 by pressing to change shapes, and relapse because of the elastic property such that the head portion 141 can fasten in the heat-dissipating hole 51 only by pressing without any other action and tool.

Since the heat-dissipating holes 51 are arranged at the two opposite sides of the game machine 50, in this exemplary embodiment, every two latches 14 are a group and mounted on a mounting plate 15 respectively. The mounting plate 316 may includes a mounting element (not shown), such as screw, to be fixed at the two side of the bottom plate 11. The position of the mounting plate 15 can be adjusted under the needs of the user and the position of the heat-dissipating hole 51.

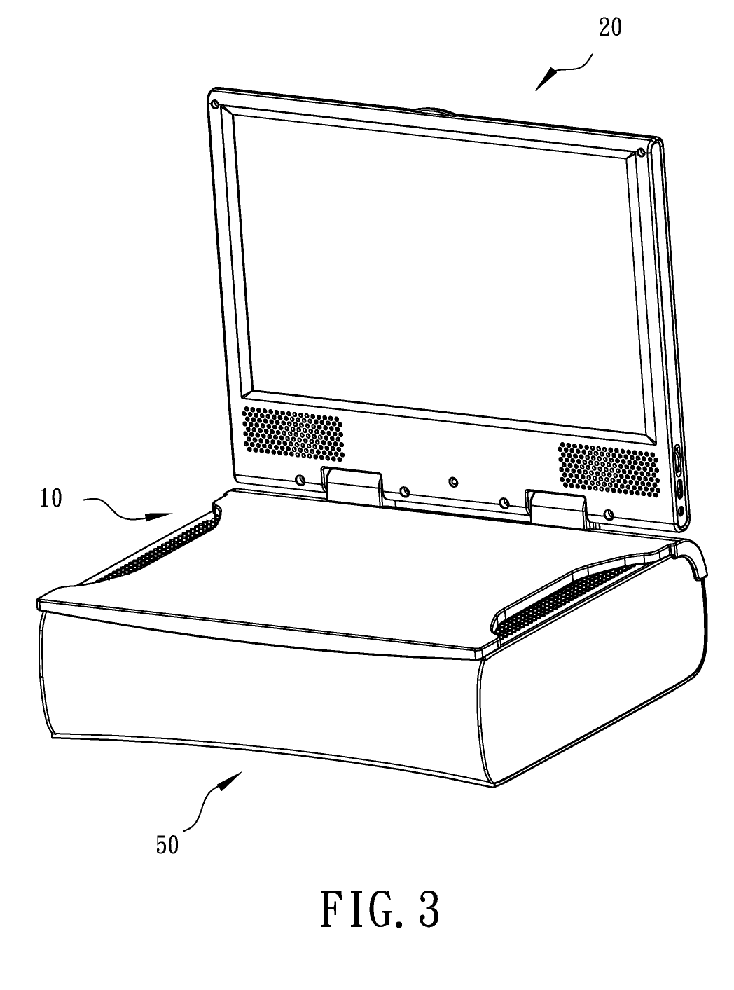

Referring to FIG. 3, in this exemplary embodiment, the display screen is coupled on the game machine 50 via directly fastening the plurality of the latches 14 of the base 10 into the heat-dissipating holes 51 of the game machine 50. The integrative structure is simple and compact. Furthermore, the display screen is assembled on the game machine 50 only via an action without any tool. Therefore, the assembly is simple. The display screen can be used and schlepped with the game machine 50 such that it is not limited by the space and the operating position.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display screen used in a game machine having a plurality of heat-dissipating holes, the display screen comprising:
a screen body having a bottom surface; and
a base coupled to the bottom surface of the screen body, the base having a plurality of latches arranged correspondingly to the heat-dissipating holes to fasten the heat-dissipating holes such that the screen body is fixed on the game machine.

2. The display screen used in the game machine of claim 1, wherein the game machine is XBOX 360.

3. The display screen used in the game machine of claim 1, wherein the game machine comprises a top surface, and the heat-dissipating holes are arranged at two opposite sides of the top surface of the game machine.

4. The display screen used in the game machine of claim 1, wherein the latches are made of an elastic material.

5. The display screen used in the game machine of claim 4, wherein each one of the latches comprises a head portion, the head portion passes through one of the heat-dissipating holes by pressing, and is limited to the heat-dissipating holes by relapsing.

6. The display screen used in the game machine of claim 5, wherein the heat portion has a width larger than an aperture of each of the heat-dissipating holes.

7. The display screen used in the game machine of claim 1, wherein the latches is moveable and assembled on the base to be adjusted.

8. The display screen used in the game machine of claim 1, wherein the screen body is coupled on the base, and rotate to open and close with the base.

9. The display screen used in the game machine of claim 8, wherein the screen body is coupled with the backside of the base.

10. The display screen used in the game machine of claim 9, wherein the screen body comprises a screen image facing towards the base, and the screen image may be received in a manner facing towards the base to be protected.
